(19) United States
(12) Patent Application Publication
(10) Pub. No.: US 2022/0282842 A1
(43) Pub. Date: Sep. 8, 2022

(54) CORAL SURFACE LIGHTING SYSTEM

(71) Applicant: Contemporary Visions, LLC, Larchmont, NY (US)

(72) Inventor: Robert A. Sonneman, Mamaroneck, NY (US)

(73) Assignee: Contemporary Visions, LLC, Larchmont, NY (US)

(21) Appl. No.: 17/652,045

(22) Filed: Feb. 22, 2022

Related U.S. Application Data
(60) Provisional application No. 63/199,380, filed on Dec. 22, 2020.

(51) Int. Cl. F21S 2/00; F21V 21/005; F21V 23/00; F21V 23/06; F21S 8/00

(52) U.S. Cl. CPC F21S 2/005; F21V 21/005; F21V 23/002; F21V 23/06; F21S 8/03

(57) ABSTRACT

A lighting system that includes at least one luminaire that has a base plate, a plurality of light sources affixed to the base plate and that are connected to each other by electrical wires and a cover plate that includes a plurality of lenses that allow light from the light sources to emit therethrough. At least one connector is arrangeable adjacent to the at least one luminaire to connect the luminaire to another luminaire. The combination of luminaires with connectors allows for a plurality of configurations of any size lighting system.

### CROSS-REFERENCE TO RELATED APPLICATION

This patent application claims benefit to U.S. Provisional Patent Application No. 63/199,380, filed Dec. 22, 2020, which is hereby incorporated by reference in its entirety as part of the present disclosure.

### FIELD OF THE INVENTION

This present disclosure relates generally to a luminaire and more specifically to a scalable modular lighting system that that is configured to be hung from a surface (e.g., a ceiling, wall or similar structure) and that can include a plurality of luminaires linked to each other by connecters that allows for an infinite variety of lighting configurations.

### BACKGROUND OF THE INVENTION

Known modular lighting system come in various shapes and configurations ranging from a single lighting fixture to multiple lighting fixtures that are affixable to a surface (e.g., ceiling, wall or similar structure). However, such modular lighting systems do not allow for seamless and continuous electro-mechanical connectivity between luminaires that can be configured to be an array of possible arrangements.

### SUMMARY OF THE INVENTION

In general, the present disclosure is directed to a luminaire and modular lighting systems formed from two or more luminaires that can be adjoined to each other by connectors to form a variety of scalable arrangements that project light therefrom. By adjusting the installation angle of the connectors, the same set of components can be installed in an infinite variety of configurations.

### BRIEF DESCRIPTION OF THE DRAWINGS

FIG. 1 is a perspective view of a luminaire according to an exemplary embodiment of the present disclosure;

FIG. 2 is an exploded view of the luminaire of FIG. 1 according to an exemplary embodiment of the present disclosure;

FIG. 3 is a detail view of the luminaire of FIG. 1 according to an exemplary embodiment of the present disclosure;

FIG. 4 is an assembly view the luminaire of FIG. 1 with a connector arranged adjacent to the luminaire according to an exemplary embodiment of the present disclosure;

FIG. 4A is a detail view of the luminaire of FIG. 4 showing wires from the luminaire being fed through the connector according to an exemplary embodiment of the present disclosure;

FIG. 5 is a perspective view showing two luminaires being adjoined by a connector according to an exemplary embodiment of the present disclosure;

FIG. 5A is detail view of FIG. 5 according to an exemplary embodiment of the present disclosure;

FIG. 6 is an assembly view of a plurality of luminaires adjoined by a plurality of connectors of various sizes according to an exemplary embodiment of the present disclosure;

FIG. 6A is detail view of a portion of the luminaire of FIG. 1 with a connector adjacent thereto that can be orientated at various locations about an exterior surface of the luminaire according to an exemplary embodiment of the present disclosure;

FIGS. 7A-7C are detail views of various connectors that abut the plurality of luminaires of FIG. 6 according to an exemplary embodiment of the present disclosure; and

FIGS. 8-12 are views scalable modular lighting systems utilizing multiple luminaires of FIG. 1, according to exemplary embodiments of the present disclosure.

### DETAILED DESCRIPTION OF EMBODIMENTS OF THE INVENTION

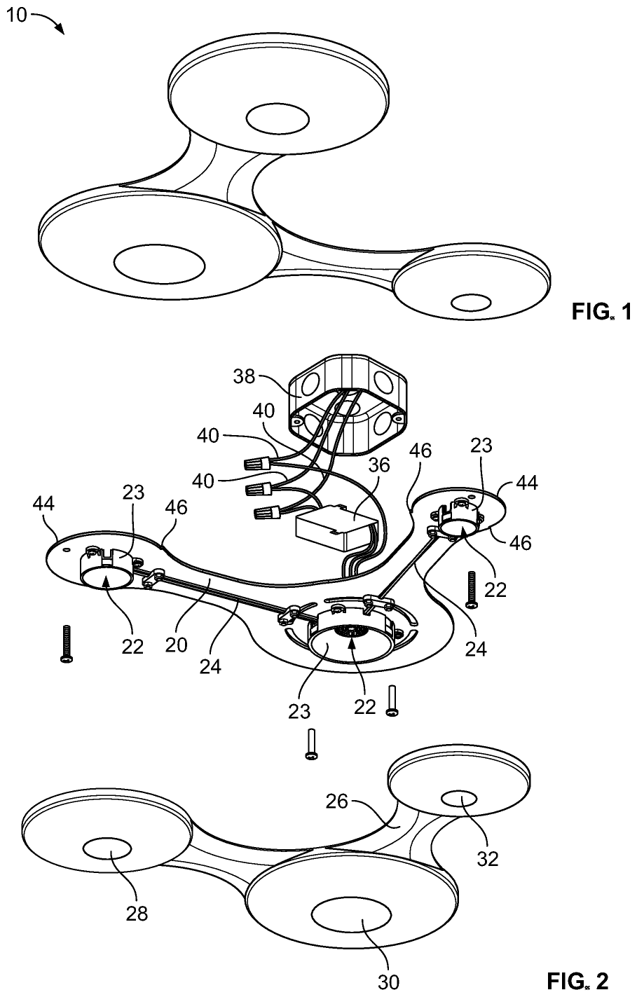

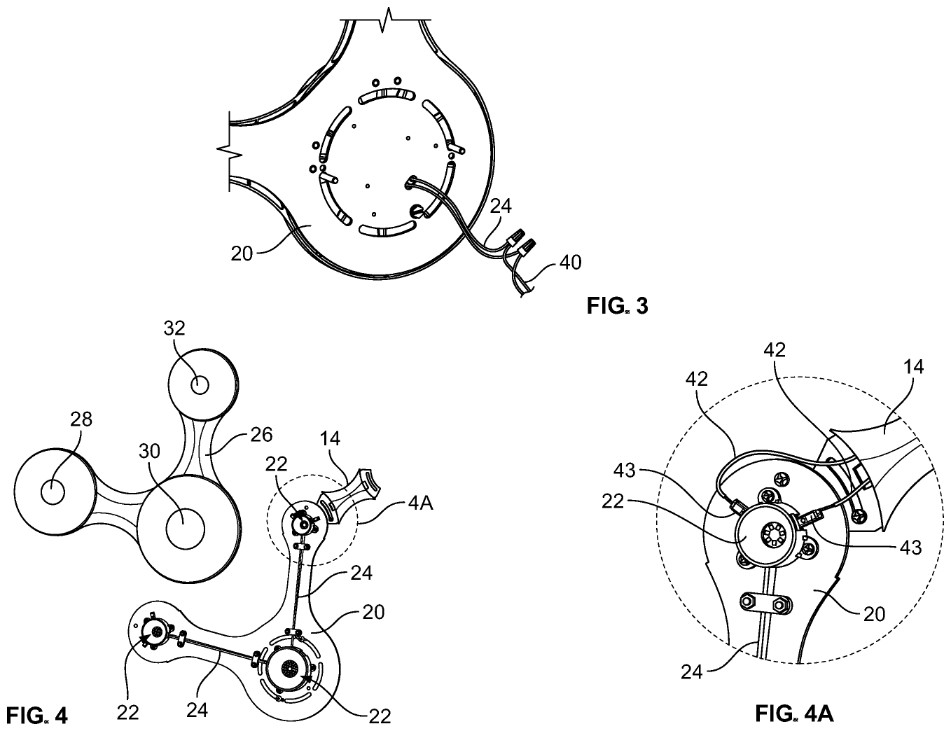

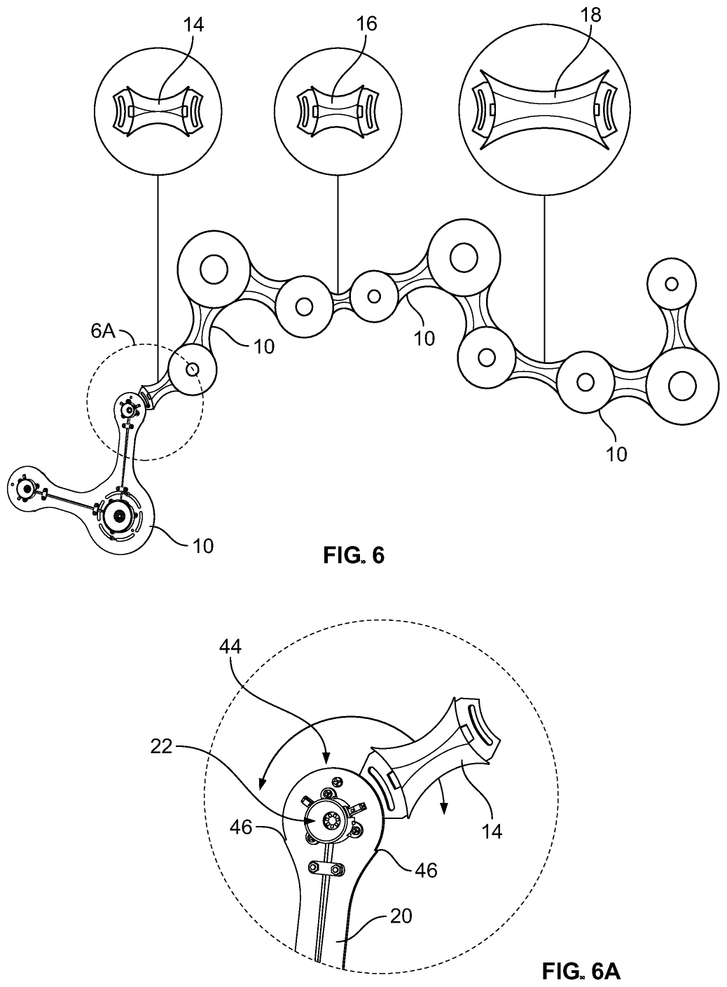

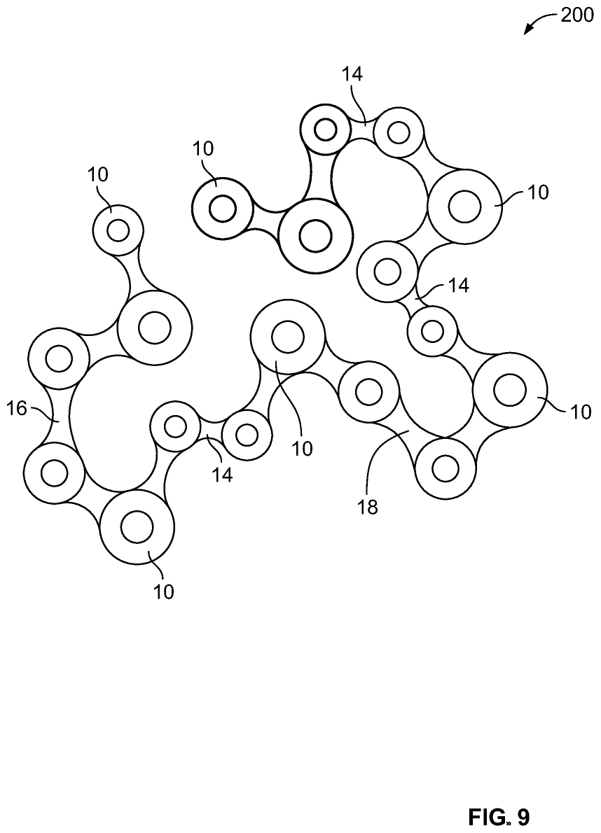

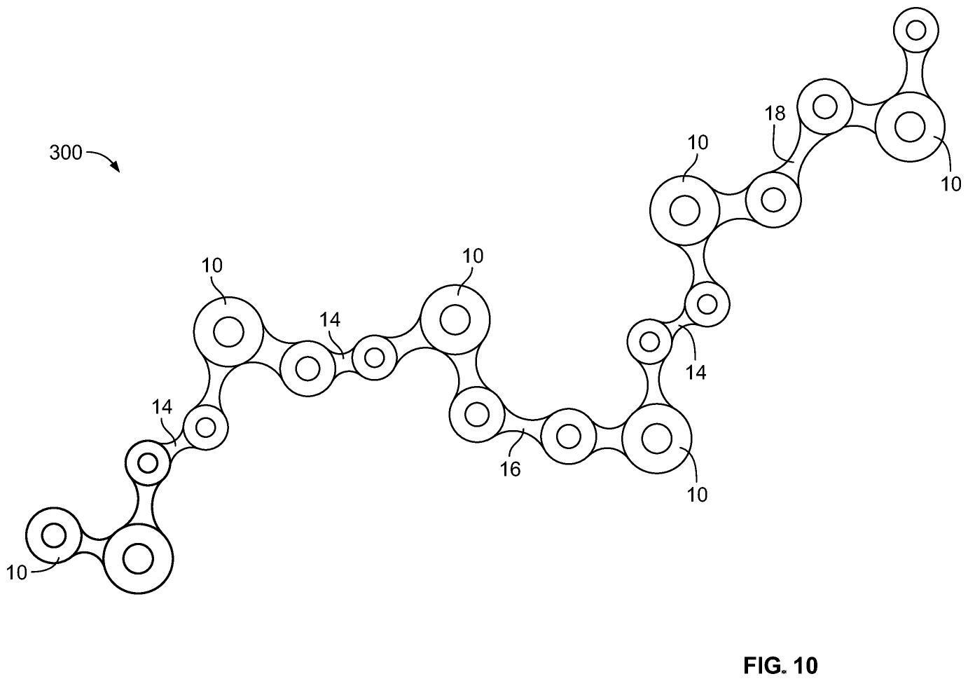

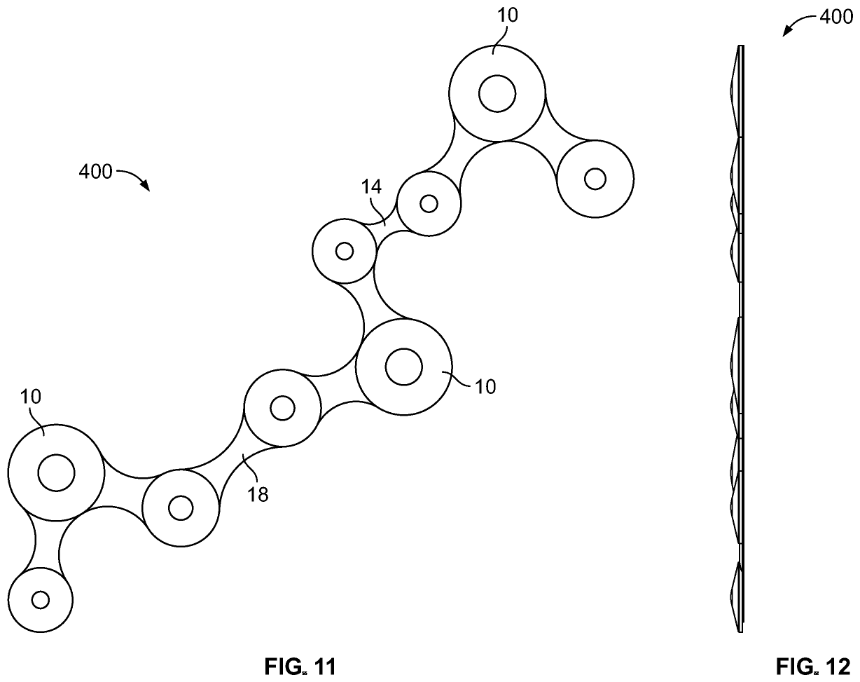

With reference now to the drawings, and in particular to FIGS. 1 through 12, embodiments of a luminaire and modular lighting systems formed from at least two luminaires embodying the principles and concepts of the present invention will be described.

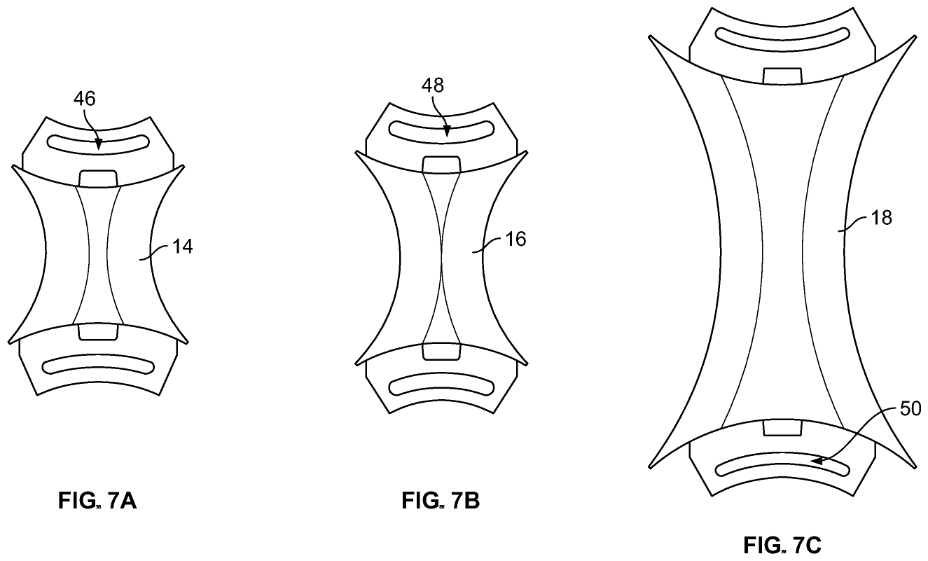

FIGS. 1-7C depict a luminaire 10 that is configured to be hung from a surface (e.g., a ceiling, wall or similar structure). The luminaire 10 is scalable, allowing for an infinite number of configurations, by linking a plurality of the luminaires 10 to each other connectors, such as the connectors 14, 16, 18 shown in FIGS. 7A-7C, to form a modular lighting system.

The luminaires 10 each include a mounting plate 20 on which a plurality of light sources (e.g., LEDs) 22 are arranged. The light sources 22 are surrounded by housings 23 and interconnected to each other by electrical wires 24. A cover plate 26 that includes three lenses 28, 30, 32, which allows light to be emitted therethrough, is releasably fixable (e.g., snap fit) to the mounting plate 20 creating an aesthetically pleasing appearance. The lenses 28, 30, 32 can, for example, be opaque, transparent or the like.

Each lighting system requires at least one luminaire 10 to act as a power source for the other luminaires 10, should the system include more than one luminaire 10. That is, at least one luminaire 10 is electrically connected to an external power source as can be seen, for example, in FIG. 1. The luminaire 10 can be connected to the power source at least in part by a transformer 36 that is arrangeable in a junction box 38 and through which electrical wires 40 extend.

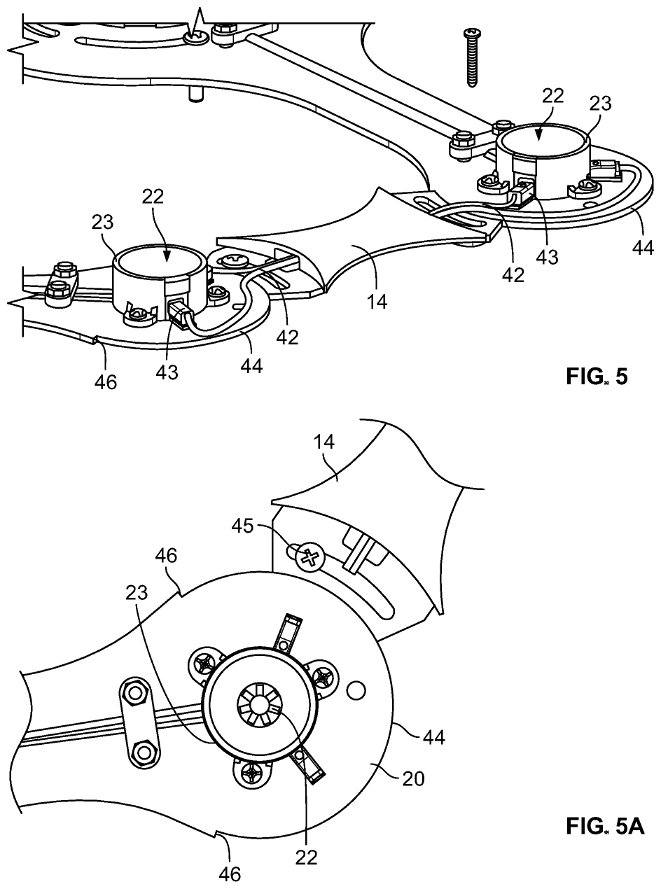

As depicted in FIGS. 4A and 5, additional electrical wires 42 electrically connect one luminaire 10 to another luminaire 10. To both ensure a secure electrical connection between luminaires 10 and ensure minimal assembly. The wires 42 can include connectors 43, such as push-in wire connectors. The wires 42 can extend between luminaires 10 via the connectors 14, 16, 18, which conceal the wires 42 creating an aesthetically appealing appearance while at the same time providing support for the wires 42 between connection points.

The connectors 14, 16, 18 are arranged adjacent an external curved surfaces 44 of the mounting plate 20 and can be positioned anywhere about the curved surfaces 44 of the mounting plate 20 with stops 46 delimiting the orientation of the connectors 14, 16, 18 in relation to the mounting plate 20.

To secure the lighting system 100, 200, 300, 400 to a surface, fasteners (e.g., screws, nails, etc.) or the like are inserted through openings or slots on the base plate 20. Then, the connectors 14, 16, 18 are arranged in a desired orientation with respect to the base plate 20 and secured to the surface using fasteners 45 that can extend through slotted regions 46, 48, 50 of the connectors 14, 16, 18, respectively. While the slotted openings 46, 48, 50 are depicted herein, it is noted that the connectors 14, 16, 18 can have a plurality of holes, one of which the fastener can be arranged or any other known connection or connection mechanism to the plate 20.

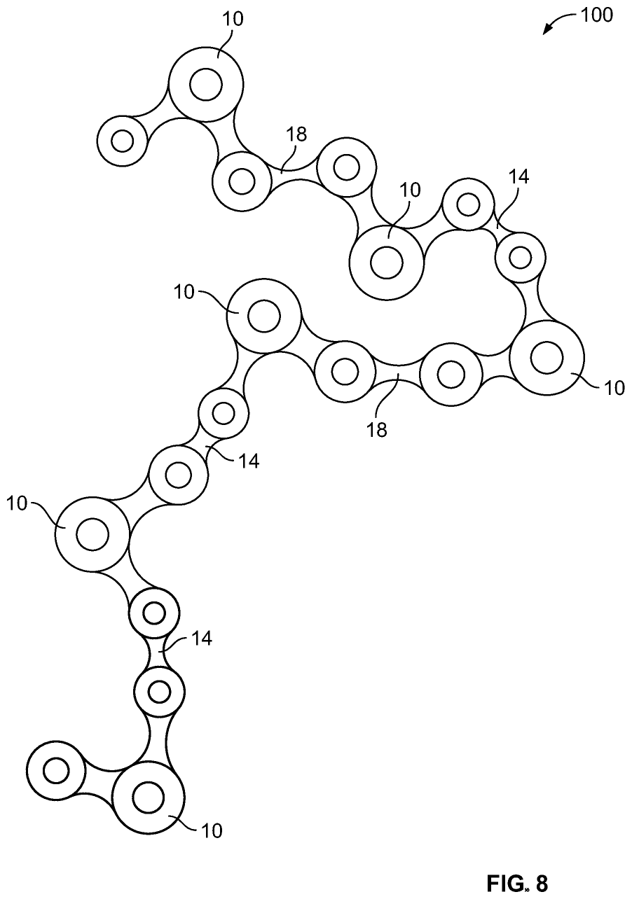

FIGS. 8-12 depict various configurations of lighting systems 100, 200, 300, 400, respectively, that are comprised of a plurality of the luminaires 10 and connectors 14, 16, 18 with at least one of the luminaires 10 directly connected to a power source to provide power to the lighting system 100, 200, 300, 400.

Although the description above and accompanying drawings contains much specificity, the details provided should not be construed as limiting the scope of the embodiments, but merely as describing some of the features of the embodiments. The description and figures should not to be taken as restrictive and are understood as broad and general teachings in accordance with the present invention. While the embodiments have been described using specific terms, such description is for illustrative purposes only, and it is to be understood that modifications and variations to such embodiments, including, but not limited to, the substitutions of equivalent features and terminology may be readily apparent to those of skill in the art based upon this disclosure without departing from the spirit and scope of the invention.

What is claimed is:

1. A luminaire, comprising:
a base plate;
a plurality of light sources affixed to the base plate;
electrical wires connecting the light sources to each other; and
a cover plate that includes a plurality of lenses that allow light from the light sources to emit therethrough releasably affixed to the base plate.

2. A lighting system, comprising:
at least two luminaires that includes a base plate, a plurality of light sources affixed to the base plate, electrical wires connecting the light sources to each other and a cover plate that includes a plurality of lenses that allow light from the light sources to emit therethrough that is releasably fixed to the base plate; and
a connector that is arrangable between and contactable with the at least two luminaires.

3. The lighting system, further comprising at least one connector arrangeable adjacent to the at least one luminaire.
